(19) United States
(12) Patent Application Publication
(10) Pub. No.: US 2024/0329817 A1
(43) Pub. Date: Oct. 3, 2024

(54) METHOD AND APPARATUS FOR PUBLISHING VIRTUAL OBJECT, DEVICE, MEDIUM, AND PROGRAM

(71) Applicant: Beijing Zitiao Network Technology Co., Ltd., Beijing (CN)

(72) Inventor: Long LI, Beijing (CN)

(21) Appl. No.: 18/617,066

(22) Filed: Mar. 26, 2024

(30) Foreign Application Priority Data
Mar. 29, 2023 (CN) 202310324273.0

(51) Int. Cl. G06F 3/04845; A63F 13/25; A63F 13/87; G06F 3/04815; G06F 3/0486

(52) U.S. Cl. CPC G06F 3/04845; A63F 13/25; A63F 13/87; G06F 3/04815; G06F 3/0486; A63F 2300/5553; G06F 2203/04804

(57) ABSTRACT

A method and apparatus for publishing a virtual object, a device, a medium, and a program are provided, and the method includes: displaying a publishing container and at least one virtual object, the publishing container being a 3D polyhedron; and in response to a first operation, publishing a virtual object completely contained in the publishing container.

### CROSS-REFERENCE TO RELATED APPLICATION

The present application claims priority of the Chinese Patent Application No. 202310324273.0, filed on Mar. 29, 2023, the entire disclosure of which is incorporated herein by reference as part of the present application.

### TECHNICAL FIELD

Embodiments of the present disclosure relate to a method and apparatus for publishing a virtual object, device, medium, and program.

### BACKGROUND

Extended Reality (XR) refers to the combination of real and virtual through the computer to create a virtual environment for human-computer interaction, XR is also a collective term for a variety of technologies such as Virtual Reality (VR), Augmented Reality (AR) and Mixed Reality (MR). By integrating the visual interaction technologies of the three, it brings a sense of “immersion” between the virtual world and the real world to the experiencer seamlessly.

In the XR scenario, in order to meet the needs of the user personalization, a User Generated Content (UGC) function is added, i.e., the user can customize a virtual object such as a virtual scenario, a virtual prop, etc. according to the user's needs in an editor capable of providing some polygons, controls, materials, logic, materials, music, sound effects, etc. for the user to select and use. After the user-defined virtual object is published, other users can view or use the virtual object.

In the existing solution, a publishing control of a virtual object is provided in an editor, through which a user publishes the virtual object, and the publishing method cannot meet the user's needs.

### SUMMARY

Embodiments of the present disclosure provide a method for publishing a virtual object, and the method includes:
displaying a publishing container and at least one virtual object, the publishing container being a 3D polyhedron;
in response to a first operation, publishing a virtual object completely contained in the publishing container.

In some embodiments, in response to a first operation, publishing a virtual object completely contained in the publishing container comprises:
in response to a first operation on the virtual object, moving the virtual object into the publishing container;
in response to detecting that the virtual object is completely contained in the publishing container, publishing the virtual object.

In some embodiments, before displaying at least one virtual object, the method further includes:
creating the virtual object in the publishing container, the virtual object created being completely contained in the publishing container.

In some embodiments, in response to a first operation, publishing a virtual object completely contained in the publishing container includes:
in response to receiving a publishing instruction, publishing the virtual object.

In some embodiments, a publishing control is displayed at a preset position of the publishing container;
in response to receiving a publishing instruction, publishing the virtual object, includes:
in response to a second operation on the publishing control, publishing the virtual object.

In some embodiments, a first control is displayed at a preset position of said publishing container,
in response to receiving a publishing instruction, publishing the virtual object, includes:
receiving a third operation on the first control and displaying an interaction panel, a publishing control being displayed on the interaction panel;
in response to a second operation on the publishing control, publishing the virtual object.

In some embodiments, in response to a first operation on the virtual object, moving the virtual object into the publishing container includes:
in response to a moving operation on the virtual object, moving the virtual object into the publishing container.

In some embodiments, in response to a first operation on the virtual object, moving the virtual object into the publishing container includes:
in response to the first operation on the virtual object, moving a center position of the virtual object to a center position of the publishing container.

In some embodiments, the method further includes:
when a partial area of the virtual object is detected to be located outside the publishing container, displaying prompt information.

In some embodiments, when a partial area of the virtual object is detected to be located outside the publishing container, displaying prompt information, includes:
when a partial area of the virtual object is detected to be located outside the publishing container and no operation on the virtual object is detected within a preset period of time, displaying prompt information.

In some embodiments, when a partial area of the virtual object is detected to be located outside the publishing container, displaying prompt information, includes:
when a partial area of the virtual object is detected to be located outside the publishing container, controlling the virtual object whose partial area is located outside the publishing container and/or the publishing container to display a preset special effect.

In some embodiments, the preset special effect of the virtual object includes: peripheral blinking or highlighting of the virtual object; or
the preset special effect of the publishing container includes at least one of following special effects: a change in color of an edge of the publishing container, a change in color of an exceeding area of the virtual object on the publishing container, or a change in color of an exceeding surface of the virtual object on the publishing container, where a partial area of the virtual object is located outside the publishing container.

In some embodiments, the method further includes:
in response to a moving operation on the virtual object, moving a position of the virtual object, causing the virtual object to be completely contained in the publishing container;
and/or, in response to an adjustment operation on the virtual object, adjusting a size of the virtual object, causing the virtual object to be completely contained in the publishing container.

In some embodiments, the method further includes:

in response to detecting that a target model touches an edge of the publishing container, controlling a touching area or a surface where the touching area is located to be displayed differently from other areas of the publishing container, wherein the target model is a virtual model of a controller corresponding to an extended reality scenario.

In some embodiments, a skeletal structure of a virtual item is displayed in the publishing container, the skeletal structure of the virtual item includes a plurality of skeletal nodes;

in response to a first operation, publishing a virtual object completely contained in the publishing container, includes:

in response to the first operation, publishing the virtual object completely contained in the publishing container and mounted on a corresponding skeletal node.

In some embodiments, the method further includes:
in response to detecting that the virtual object overlaps the skeletal node, determining that the virtual object is mounted on the skeletal node.

In some embodiments, a plurality of virtual objects are completely contained in the publishing container;
in response to a first operation, publishing a virtual object completely contained in the publishing container, includes:
in response to the first operation, publishing a combined virtual object, the combined object comprising the plurality of virtual objects completely contained in the publishing container.

In some embodiments, in response to the first operation, publishing a combined virtual object, includes:
in response to the first operation, publishing each virtual object completely contained in the publishing container as a sub virtual object of the combined virtual object.

In some embodiments, a plurality of virtual objects are completely contained in the publishing container;
in response to a first operation, publishing a virtual object completely contained in the publishing container, includes:
in response to the first operation, publishing a plurality of independent virtual objects, each independent virtual object corresponding to a virtual object completely contained in the publishing container.

In some embodiments, the size of the publishing container is determined based on a size threshold of a virtual object in an application.

In some embodiments, the size of the publishing container is determined based on a size threshold of a virtual object in an application, the size threshold corresponding to different types of virtual objects being different.

In some embodiments, the publishing container is a transparent entity or a translucent entity.

In some embodiments, displaying a publishing container includes:
in response to a summoning instruction with respect to the publishing container, displaying the publishing container.

In some embodiments, the method further includes:
in response to a closing instruction with respect to the publishing container, hiding the publishing container.

In some embodiments, the virtual object is a user-defined object.

Embodiments of the present disclosure provide an apparatus for publishing a virtual object, and the apparatus includes:
a display module configured to display a publishing container and at least one virtual object, the publishing container being a 3D polyhedron;
a publishing module configured to, in response to a first operation, publish a virtual object completely contained in the publishing container.

Embodiments of the present disclosure provide an electronic device which includes a processor and a memory, the memory is configured to store computer programs, the processor is configured to call and run the computer programs stored in the memory to execute the method according to any one of the above.

Embodiments of the present disclosure provide a non-transient computer-readable storage medium which is configured to store computer programs, the computer programs cause a processor to execute the method according to any one of the above.

Embodiments of the present disclosure provide a computer program product which includes computer programs, the computer programs upon being executed by a processor, implement the method according to any one of the above.

### BRIEF DESCRIPTION OF DRAWINGS

To clearly illustrate the technical solution of the embodiments of the present disclosure, the drawings required in the description of the embodiments will be briefly described in the following; it is obvious that the described drawings are only some embodiments of the present disclosure. For those skilled in the art, other drawings can be obtained based on these drawings without any inventive work.

FIG. 1 is a flowchart of a method for publishing a virtual object according to an embodiment of the present disclosure;

FIG. 2 is a schematic diagram of a publishing container;

FIG. 3 is another schematic diagram of a publishing container;

FIG. 4 is a schematic diagram of an interaction panel of a publishing container;

FIG. 5 is a schematic diagram of the display effect of a publishing container in different states;

FIG. 6 is a flowchart of a method for publishing a virtual object according to an embodiment of the present disclosure;

FIG. 7 is a flowchart of a method for publishing a virtual object according to an embodiment of the present disclosure;

FIG. 8 is a schematic diagram of the publishing of a virtual character;

FIG. 9 is a flowchart of a virtual object publishing method according to an embodiment of the present disclosure;

FIG. 10 is a structural schematic diagram of an apparatus for publishing a virtual object according to an embodiment of the present disclosure;

FIG. 11 is a structural schematic diagram of an electronic device according to an embodiment of the present disclosure.

### DETAILED DESCRIPTION

The technical solutions of the embodiments of the present disclosure will be described clearly and fully understandable in conjunction with the drawings related to the embodiments of the present disclosure. Apparently, the described embodiments are just a part but not all of the embodiments of the present disclosure. Based on the described embodiments herein, those skilled in the art can obtain other embodiment(s), without any inventive work, which should be within the scope of the present disclosure.

It should be noted that the terms “first”, “second”, etc. in the description and claims of the present disclosure, as well as the drawings, are used to distinguish similar objects and do not need to be used to describe a specific sequence or order. It should be understood that the data used in this way can be interchanged in appropriate cases so that the embodiments of the present disclosure described here can be implemented in order other than those illustrated or described here. In addition, the terms “comprise/comprising” and “include/including” and any variations thereof are intended to cover a non-exclusive inclusion. For example, a process, method, system, product, or server that includes a series of steps or units, need not be limited to those clearly listed steps or units but may include other steps or units that are not clearly listed or inherent to these processes, methods, products, or devices.

In order to facilitate the understanding of the embodiments of the present disclosure, some concepts involved in all the embodiments of the present disclosure are first explained appropriately before describing the various embodiments of the present disclosure, as follows:

XR is a collective term for VR, AR, and AR technology, and the XR device includes, but is not limited to, the VR device, the AR device, and the MR device.

VR is a technology to create and experience virtual worlds, computationally generate a virtual environment, is a multi-source information (virtual reality as referred to herein includes at least visual perception, but may also include auditory perception, tactile perception, motion perception, and even taste perception, olfactory perception, etc.), enables fused, interactive, three-dimensional (3D) dynamic vision and simulation of physical behavior of virtual environments, immerses the user into a simulated virtual reality environment, enables applications in multiple virtual environments such as mapping, gaming, video, education, medical, simulation, co-training, sales, assisting in manufacturing, maintenance, and repair.

The VR device refers to a terminal implementing a virtual reality effect, and may be generally provided in the form of glasses, a head mount display (HMD), contact lens for implementing visual perception and other forms of perception, of course the form implemented by the virtual reality device is not limited thereto, and may be further miniaturized or enlarged as needed.

AR: AR scenario refers to a simulated scenario in which at least one virtual object is superimposed on top of a physical scenario or a representation thereof. For example, the electronic system may have an opaque display and at least one imaging sensor for capturing images or video of the physical scenario, the images or video being a representation of the physical scenario. The system combines the image or video with the virtual object and displays the combination on an opaque display. Individuals use the system to indirectly view physical scenario via images or videos of the physical scenario, and observe the virtual object superimposed on top of the physical scenario. When the system captures images of the physical scenario using one or more image sensors, and uses those images to present the AR scenario on an opaque display, the displayed images are referred to as video transparent transmission. Alternatively, the electronic system for displaying AR scenario may include a transparent or translucent display through which the individual may directly view the physical scenario. The system may display the virtual object on a transparent or translucent display such that the individual uses the system to view the virtual object superimposed on top of the physical scenario. As another example, the system may include a projection system that projects the virtual object into the physical scenario. The virtual object may be projected, for example, on a physical surface or as a hologram, such that the individual uses the system to view the virtual object superimposed on top of the physical scenario. Specifically, a technique for calculating a camera pose parameter of the camera in the real world (or three-dimensional world, real world) in real time during image capture by the camera and adding a virtual element to the image captured by the camera based on the camera pose parameter. The virtual element includes, but is not limited to: an image, a video, and a three-dimensional model. The goal of AR technology is to socket the virtual world to the real world on the screen for interaction.

MR: By presenting virtual scenario information at the real scenario, one interactive feedback information loop is lapped between the real world, the virtual world and the user to enhance the realism of the user experience. For example, integrating computer-created sensory inputs (e.g., virtual objects) with sensory inputs from physical scenario or representations thereof in simulated scenario, in some MR scenario, the computer-created sensory inputs may adapt to changes in the sensory inputs from physical scenario. In addition, some electronic systems used to present MR scenario may monitor orientation and/or position relative to the physical scenario to enable virtual objects to interact with real objects (i.e., physical elements or representations thereof from the physical scenario). For example, the system may monitor motion such that the virtual plant appears to be stationary relative to the physical building.

A virtual reality device (VR device), a terminal implementing a virtual reality effect, may be generally provided in the form of glasses, a head mount display (HMD), contact lens for implementing visual perception and other forms of perception, of course the form implemented by the virtual reality device is not limited thereto, may be further miniaturized or enlarged according to actual needs.

Alternatively, the virtual reality device (i.e., XR device) recited in the embodiments of the present disclosure may include, but is not limited to, several types as follows:
1) A mobile virtual reality device, which supports setting up a mobile terminal (such as a smartphone) in various ways (such as a head-mounted display provided with a special card slot), performing calculations related to virtual reality functions by the mobile terminal through a wired or wireless connection with the mobile terminal, and outputting data to the mobile virtual reality device, such as viewing virtual reality video through an APP of the mobile terminal.
2) The all-in-one virtual reality device, which has a processor for performing calculations related to virtual functions, thus has independent virtual reality input and output functions, does not need to be connected to a PC terminal or a mobile terminal, and uses a high degree of freedom.
3) a computer-end virtual reality (PCVR) device, which uses the PC-end to perform relevant calculations of virtual reality functions and data output, and the external computer-end virtual reality device uses the data output by the PC terminal to achieve the effect of virtual reality.

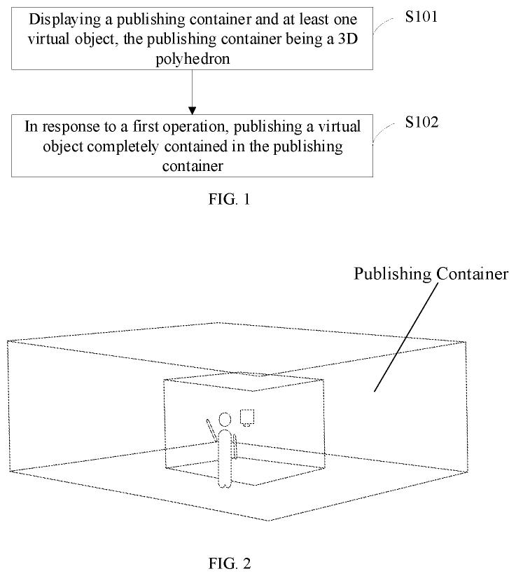

FIG. 1 is a flowchart of a method for publishing a virtual object according to Embodiment 1 of the present disclosure. The method is applied in an XR device. As illustrated in FIG. 1, the method provided by the present embodiment includes the following steps.
S101, displaying a publishing container and at least one virtual object, the publishing container being a 3D polyhedron.

The virtual object is an object displayed in the extended reality scenario, and may be a virtual entity, a virtual prop, a virtual character, or the like in the extended reality scenario. The virtual object may include one or more geometric bodies, virtual elements, or controls.

The virtual entity may be a plant, an animal, a building, etc. in the extended reality scenario.

The virtual character, Avatar, is a synonym for the virtual figure of the network user in an image-dominated virtual world. Such virtual characters are typically cartoon figures and may appear in chat rooms or in games.

Virtual props are typically some movable entities that can be used by a virtual character in an extended reality scenario, and in a game scenario, virtual props are also referred to as game props. Virtual props include task props, equipment props, and consumable items, among others.

In this embodiment, the virtual object may be an object provided by the application itself or may be a user-defined object.

Taking the XR device as an example, the UGC function is added in order to meet the user's personalized needs, i.e., the user can customize a virtual scenario, a virtual prop, a virtual character, a virtual entity, or the like in the editor provided according to the user's needs. The editor can provide editing elements such as polyhedrons, controls, materials, physics, logic, music, sound effects, special effects, and materials for use by the user. The user in the editor can define a virtual object and a virtual scenario, the user's customized virtual scenario also referred to as the user's own world, and other users can enter the user's customized scenario for play. The user-defined virtual scenario may be referred to as a UGC world or UGC scenario. The User-defined virtual object is also referred to as a UGC object, and a user-defined prop may be referred to as a UGC prop. Customization in embodiments of the present disclosure may be understood as an entity or scenario that a user builds up autonomously in an editor using the editing element provided by the editor.

After creating the virtual object, the user may publish the virtual object created by the user, and publishing the virtual object may include saving the virtual object locally to the user, or uploading the virtual object to a network or a fixed platform after saving the virtual object, the virtual object saved locally to the user can only be viewed by the user, and cannot be viewed by other users, and the virtual object uploaded to the network or a fixed platform can also be viewed by other users. If a user-defined virtual object is not published, only the user can view or use it.

In the related art, a user, after creating a virtual object, can publish it through a publishing control on a creation page in a single manner. In the embodiments of the present disclosure, a publishing container is created through which the virtual object is published.

The publishing container is a 3D polyhedron, the 3D polyhedron may be a trihedron, a tetrahedron, a pentahedron, a hexahedron, etc., the tetrahedron may be a regular tetrahedron or a non-regular tetrahedron, and the hexahedron may be a regular hexahedron or a non-regular hexahedron, and the present disclosure does not limit the specific shape of the 3D polyhedron.

The publishing container contains less than the entire space of the current extended reality scenario, i.e., the publishing container contains only part of the space in the current extended reality scenario.

Optionally, the publishing container is a transparent entity or a translucent entity, so that after the virtual object is placed in the publishing container, the user can see the virtual object through the publishing container, as well as clearly identify the location of the publishing container and the virtual object it contains through the border at the intersection of the transparent surfaces or the translucent publishing container.

In one implementation, a publishing container is displayed in an editing space of an editor when a user enters the editing space of the editor, the publishing container may be displayed in a fixed position of the editing space, e.g., in an upper right position of the editing space. The user then creates a virtual object in the editing space, and after the creation is complete, the virtual object may be published using the publishing container.

In another implementation, the publishing container is not displayed when the user enters the editing space of the editor, and the user summons the publishing container when the user needs to use the publishing container. Accordingly, the publishing container is displayed in response to a summoning instruction with respect to the publishing container.

In embodiments of the present disclosure, the user may interact with the XR device through one or more of the following: a hand-held device (such as a handle or hand controller, etc.), a gesture operation, a voice mode, or a gaze control, and embodiments of the present disclosure are not particularly limited in this regard. Accordingly, the summoning instruction with respect to the publishing container is a summoning instruction input by the user through one or more of a hand-held device, gesture operation, voice mode, or gaze control.

Exemplarily, in the editing space, the user long presses the “Home” key via the handle, the XR device detects the long press operation of the “Home” key and correspondingly generates a summoning instruction to generate a publishing container, and in response to the summoning instruction with respect to the publishing container, displays the publishing container in the editing space.

The summoning instruction with respect to the publishing container may also be a click, a double click, a long press, a hover operation, a bump operation, a specific gesture trigger, or other operation on the virtual object.

When the publishing container is summoned by the summoning instruction, optionally, the publishing container may further be closed, and when a closing instruction with respect to the publishing container is received, the publishing container is hidden, i.e., the publishing container is closed, and the publishing container is no longer displayed in the extended reality scenario after hiding the publishing container.

In this manner, the publishing container is summoned and closed by the summoning instruction and the closing instruction, so that the user can flexibly summon or close the publishing container according to his or her own needs, avoiding occlusion of other entities in the extended reality scenario when the publishing container is not in use.

It is understood that the timing of publishing the virtual object is not limited to when the virtual object is created, the user may publish the created virtual object at any time. For example, a user, after creating a virtual object, saves a draft of the virtual object, and the user may subsequently open the saved draft of the virtual object and upload it to a network or a fixed platform. Alternatively, after the virtual object is published, the user may also modify the virtual object again and publish the virtual object after the modification is completed.

FIG. 2 is a schematic diagram of a publishing container. As illustrated in FIG. 2, the publishing container is a cuboid and the edge of the publishing container is translucent. The cuboid at the periphery of the publishing container is the boundary of the extended reality scenario where the publishing container is located. Optionally, a control is also displayed at the publishing container by which the user performs a corresponding operation on the publishing container.
S102, in response to a first operation, publishing a virtual object completely contained in the publishing container.

A plurality of virtual objects may be displayed in the extended reality space, and the method of embodiments of the present disclosure only publishes the virtual object that is completely contained in the publishing container, and does not publish the virtual object located all outside the publishing container or partially outside the publishing container. A virtual object located partially outside the publishing container means that a portion of the virtual object is located inside the publishing container and a portion is located outside the publishing container. It is to be understood that whether the virtual object is completely contained in the publishing container may be determined based on a positional relationship and/or a collision relationship between the virtual object and the publishing container.

In this embodiment, the virtual object may be published in several modes as follows.

Mode 1, in response to a first operation on the virtual object, moving the virtual object into the publishing container; in response to detecting that the virtual object is completely contained in the publishing container, publishing the virtual object.

In this mode, the virtual object is located outside the publishing container, the virtual object is moved into the publishing container by the first operation, and when it is detected that the virtual object is completely contained in the publishing container, the virtual object is automatically published without requiring the user to perform other operations.

The first operation includes, but is not limited to, a click, a double click, a hover operation, a long press, a bump, a moving operation, a specific gesture trigger, or other operation on the virtual object.

When the first operation is a moving operation, the user drags the virtual object to move, and in response to the moving operation on the virtual object, the virtual object is moved into the publishing container. The position of the virtual object in the publishing container is related to the position of the drag operation. For example, the user may drag the virtual object to an edge position of the publishing container, and may also drag the virtual object to a center position of the publishing container.

When the first operation is a non-moving operation, after the user performs the first operation on the virtual object, in response to the first operation on the virtual object, a center position of the virtual object is moved to a center position of the publishing container. That is, after the user performs the first operation on the virtual object, the virtual object is automatically placed at the center position of the publishing container. The center position of the virtual object is made to coincide with the center position of the publishing container by moving the center position of the virtual object to the center position of the publishing container.

Mode 2, the virtual object is created in the publishing container, and the created virtual object is completely contained in the publishing container. That is, before displaying the at least one virtual object, the virtual object is created in the publishing container, and the created virtual object is completely contained in the publishing container. Accordingly, the first operation is to receive a publishing instruction to publish the virtual object according to the publishing instruction.

Relative to mode 1, the mode does not require moving the virtual object from outside the publishing container to inside the publishing container, after the virtual object is created in the publishing container, the virtual object is displayed completely in the publishing container. At this time, the user triggers the publication of the virtual object by the first operation, which may be an operation on the publishing control.

Mode 3, in response to the first operation on the virtual object, the virtual object is moved to the publishing container, in response to detecting that the virtual object is completely contained in the publishing container, and to receiving a publishing instruction, the virtual object is published according to the publishing instruction.

The difference between mode 3 and the mode 1 is that a user operation is required after the virtual object has been completely moved to the publishing container, i.e., the user is required to trigger the publishing instruction before the virtual object is published.

Illustratively, a user may trigger a publishing instruction in the following implementations.

In one implementation, a publishing control is displayed at a preset position of the publishing container, and the user generates the publishing instruction by performing a second operation on the publishing control.

The second operation includes, but is not limited to, a click, a double click, a hover operation, a long press operation, and the like on the virtual object.

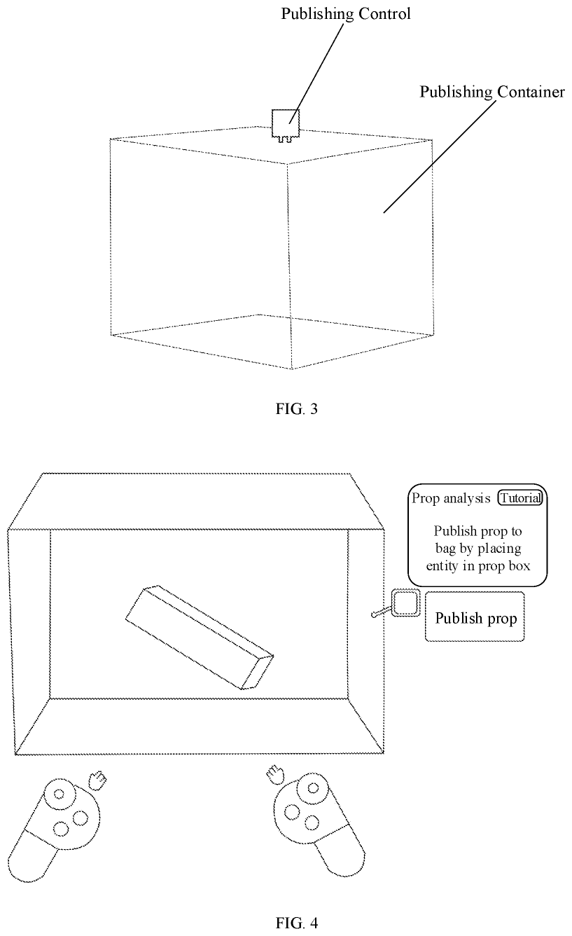

FIG. 3 is another schematic diagram of a publishing container. As illustrated in FIG. 3, the control displayed on the upper surface of the publishing container is the publishing control. The publishing control is displayed along with the publish container.

Alternatively, the publishing control may be not displayed along with the publishing container, but after the publishing container is displayed, when a certain display condition is met. For example, the publishing control is displayed upon detecting that the virtual object is completely contained within the publishing container, or the publishing control is displayed upon detecting that the virtual object touches the publishing container.

In another implementation, a first control is displayed at a preset position of a publishing container, a third operation on the first control is received, an interaction panel is displayed with the publishing control and other information displayed thereon, and a publishing instruction is generated when a second operation on the publishing control is received.

The other information on the interaction panel includes, but is not limited to, publishing guidance information for guiding the user how to do the publishing operation, and the user can open the interaction panel when there is a need for publishing, learn how to do the publishing operation through the publishing guidance information, and after placing the virtual object to be published into the publishing container, open the interaction panel again for publishing through the publishing control on the interaction panel.

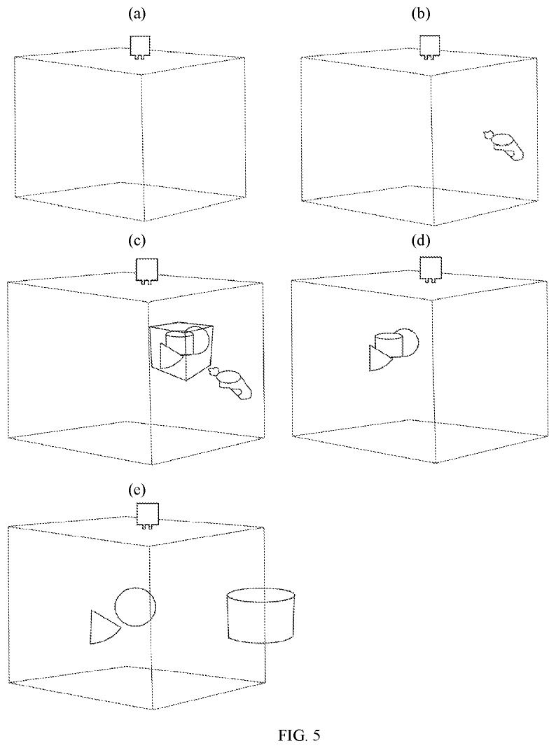

FIG. 4 is a schematic diagram of an interaction panel of a publishing container. As illustrated in FIG. 4, after placing a virtual object in the publishing container, the interaction panel is opened through a first control on the publishing container. The interaction panel is divided into two parts. The “publish prop” control located above the interface is the publishing control.

Optionally, a closing control is also displayed on the interaction interface, and the user closes the interaction panel through the closing control.

Optionally, after the virtual object is published successfully, notification information of the successful publication is displayed at a preset position of the publishing container, and likewise, after the virtual object is failed to be published, notification information of the failure to be published is displayed at a preset position of the publishing container.

After the virtual object is published successfully, the virtual object disappears from the publishing container, the publishing container can continue to be used for the publication of other virtual objects.

In this embodiment, the size of the publishing container can be determined in several ways as follows:

In an optional way, the size of the publishing container is determined based on a threshold size of the virtual object in the application.

The sizes of the various virtual objects may not be uniform in the application, but the sizes of the various virtual objects all have a certain range within which the sizes of all the virtual objects should lie, for example, setting the size threshold of the virtual objects in the application to be 2 meters in length, width, and height, respectively, that is, all the virtual objects in the application should be less than 2 meters in length, width, and height.

The size of the publishing container may be equal to or smaller than the size threshold, and in this embodiment the virtual object will not be published after the virtual object is completely received in the publishing container, thereby ensuring that the size of the published virtual object does not exceed the size threshold of the virtual object in the application so that the size of the published virtual object meets the requirements.

Optionally, the size of the publishing container may also be slightly larger than the size threshold, e.g. increased by a certain length based on the size threshold of the virtual object in the application, e.g. by 0.1 meter.

In another optional way, the size of the publishing container may be determined according to a size threshold corresponding to the type of virtual object in the application, and different types of virtual objects may correspond to different size thresholds.

Illustratively, the type of the virtual object includes a virtual character and a virtual prop, and a first publishing container used by the virtual character is of a different size than a second publishing container used by the virtual prop. Assuming that the threshold size of the virtual character in the application is not more than 3 meters in height, 2 meters in length and 2 meters in width, and the threshold size of the virtual prop in the application is not more than 2 meters in length, width, and height, the first publishing container used by the virtual character is 2 meters in length, width, and 3 meters in height, and the second publishing container used by the virtual prop is 2 meters in length, width, and height, respectively.

In yet another optional way, the size of the publishing container may be a preset fixed value, and the size of the publishing container is not determined based on the size threshold of the virtual object in the application.

In this embodiment, after placing the virtual object into the publishing container, the user can visually perceive the size of the virtual object using the publishing container as a reference. If the size of the virtual object is not suitable, the size of the virtual object can be adjusted in time. On the one hand, it can avoid that the user needs to open the size setting panel to view or set the size of the virtual object after creating the virtual object because of forgetting the size of the virtual object, which makes it inconvenient to view or set the size of the virtual object. On the other hand, the virtual object is created separately, and the user cannot perceive the size of the virtual object in the actual application scenario because there is no reference after creating the virtual object. In this embodiment, the publishing container is used as a reference to allow the user to visually perceive the size of the virtual object.

In this embodiment, a publishing container and at least one virtual object are displayed, the publishing container is a 3D polyhedron; in response to a first operation, a virtual object completely contained in the publishing container is published. In the method, by placing the virtual object in a publishing container for publishing, the publishing of the virtual object is more consistent with the interactive operation of 3D virtual space and the user′ experience is improved. In addition, by displaying the virtual object in the publishing container for publishing, the user can visually perceive the size of the virtual object using the size of the publishing container as a reference, which facilitates the user to adjust the size of the virtual object.

Embodiment of the present disclosure defines a plurality of display states for the publishing container, and the publishing container has a different display effect in different display states. Illustratively, the publishing container includes the following four states: a normal state, an edge prompt state, an editing state, and a warning state.

Normal state: a state when there is no entity within the publishing container or the outline of the entity does not exceed the boundary of the publishing container, the edge of the publishing container being displayed translucently. The setting of the transparency of the publishing container is targeted to not interfere with user vision and operation at normal conditions.

Edge prompt state: a state of prompting the touching area when the target model is not holding a virtual object and touches the edge of the publishing container, by prompting the touching area to prompt the size and edge position of the publishing container. The virtual model of the controller corresponding to the target model extended reality scenario may be a virtual handle, a virtual hand model, or a combination of a virtual handle and a virtual hand model, and the specific form of the virtual model is not limited in this embodiment.

Optionally, the touching area is prompted by: controlling the touching area or the surface on which the touching area is located to be displayed differently from other areas of the publishing container. The color of the touching area or the surface on which the touching area is located may be changed while the color of the other areas of the publishing container is unchanged. For example, the color of the touching area or the surface on which the touching area is located changes to red while the other areas remain unchanged, so that the touching area or the surface on which the touching area is located is controlled to be displayed differently from the other areas of the publishing container.

The target model holding the virtual object means that the target model controls the virtual object to follow the movement of the target model, and when the target model holds the virtual object, the target model may or may not be in contact with the virtual object, with a distance between them, but the target model is able to control the movement of the virtual object.

Taking the target model as the virtual handle as an example, the target model not holding the virtual object means that the virtual handle is not controlling the virtual object to move, and the virtual handle is an empty handle.

Editing state: a state of the publishing container when the target model holds a virtual object close to the publishing container and moves towards the inside of the publishing container. Alternatively, the editing state of the publishing container is displayed as normal state, i.e., the edge of the publishing container is displayed translucently, and no touching area prompt is performed when the target model or virtual object touches the publishing container.

Alternatively, the editing state of the publishing container may be displayed differently than the normal state, for example, when the target model holds the virtual object close to the publishing container, the edge of the publishing container is highlighted, or the edge of the publishing container is unchanged in color, the surface of the publishing container becomes fully transparent, or a text prompt is displayed at the publishing container.

Warning state: a state of a publishing container when a partial area of a virtual object is located outside the publishing container. That is, a portion of the virtual object is inside the publishing container and a portion is outside the publishing container. In the warning state, a prompt information is displayed at the publishing container, and the prompt information is used to prompt that a partial area of the virtual object exceeds the publishing container.

Exemplarily, the prompt information is a preset special effect, and the virtual object and/or the publishing container are controlled to display the preset special effect when a partial area of the virtual object is detected to exceed a boundary of the publishing container.

The preset special effect of the virtual object includes, but is not limited to, peripheral blinking or highlighting of the virtual object. The preset special effects of the publishing container include at least one of the following special effects: a change in color of an exceeding area of the virtual object on the publishing container, or a change in color of an exceeding surface of the virtual object on the publishing container.

For example, the publishing container changes from white to red when the partial area of the virtual object exceeds the boundary of the publishing container, the edge of the publishing container changes from white to red, the exceeding area of the virtual object on the publishing container blinks red, and the periphery of the virtual object blinks.

FIG. 5 is a schematic diagram of the display effect of a publishing container in different states, as illustrated in FIG. 5(a), in which the publishing container is in a normal state, when there is no entity inside the publishing container. The user may control the empty virtual handle to move towards the publishing container, and when the virtual handle touches the edge of the publishing container, the state of the publishing container changes from the state illustrated in FIG. 5(a) to the state illustrated in FIG. 5(b), in which the publishing container is in the edge prompt state.

If the user needs to publish the virtual object, the virtual handle controlling to hold the virtual object is moved toward the publishing container, at which time the state of the publishing container is changed from the normal state to the editing state, in FIG. 5(c) the publishing container is in the editing state, in FIG. 5(c) the virtual object touches the edge of the publishing container, and after all the virtual object is moved into the publishing container, the publishing container is changed to the normal state as illustrated in FIG. 5(d). The publishing container in FIG. 5 has the same display effect in the editing state and the normal state, and it will be understood that in other embodiments of the present application, the publishing container may have a different display in the editing state and the normal state.

FIG. 5(e) shows a schematic diagram of the publishing container in the warning state, where a partial area of the cylinder exceeds the boundary of the publishing container, it being understood that in moving the cylinder from the outside to the inside of the publishing container, the cylinder will inevitably be located partly inside the publishing container and partly outside the publishing container. In one implementation, the warning state is switched to immediately as soon as the partial area of the virtual object is detected to be located outside the publishing container, and in another implementation, the warning state is switched to when the partial area of the virtual object is detected to be located outside the publishing container and no operation on the virtual object is detected within a preset period of time.

Exemplarily, the preset period of time is 2 seconds, and the user moves the cylinder while a partial area of the cylinder is outside the publishing container during the movement of the cylinder from the outside to the inside of the publishing container, so that the publishing container does not switch to the warning state during the normal movement of the cylinder to the publishing container. Only a partial area of the cylinder is outside the publishing container and the user has not performed any operation on the cylinder for a long period of time will switch to the warning state.

Typically, after moving the center position of the virtual object to the center position of the publishing container, if the virtual object still has a partial area located outside the publishing container, switching to an early warning state, in which the entity inside the publishing container cannot be published, requires the user to resize the virtual object so that the virtual object is completely located inside the publishing container before it can be published.

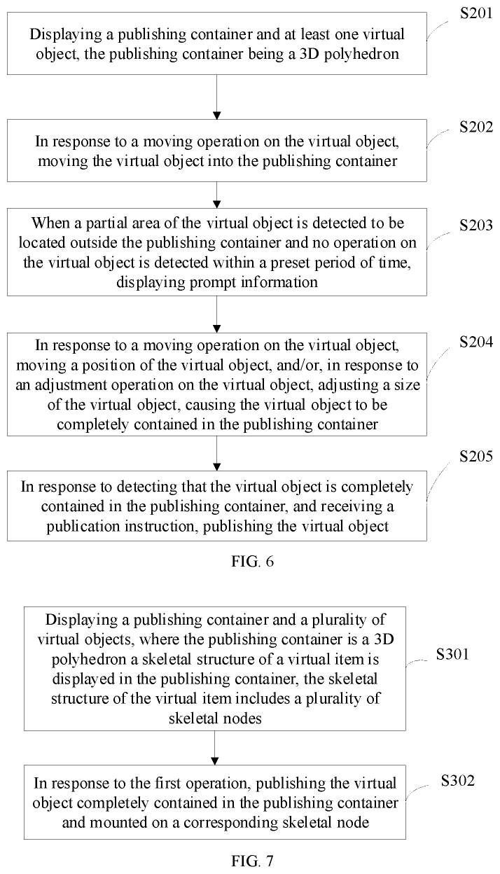

FIG. 6 is a flowchart of a method for publishing a virtual object according to an embodiment of the present disclosure, and the method for publishing the virtual object is explained in conjunction with the state of the publishing container illustrated in FIG. 5. As illustrated in FIG. 6, the method according to the present embodiment includes the following steps.
S201, displaying a publishing container and at least one virtual object, the publishing container being a 3D polyhedron.
S202, in response to a moving operation on the virtual object, moving the virtual object into the publishing container.

The virtual object is located outside the publishing container and can be moved into the publishing container when the virtual object needs to be published.
S203, when a partial area of the virtual object is detected to be located outside the publishing container and no operation on the virtual object is detected within a preset period of time, displaying prompt information.

In the process of placing the virtual object into the publishing container, the partial area of the virtual object may exceed the boundary of the publishing container because of the size of the virtual object being too large or the position of the virtual object being located at the edge of the publishing container. In this embodiment, the virtual object cannot be published when the partial area of the virtual object exceeds the boundary of the publishing container, and the virtual object can be published only when the virtual object is completely contained in the publishing container.

In this embodiment, the prompt information is displayed when it is detected that the partial area of the virtual object is located outside the publishing container, or when it is detected that the partial area of the virtual object is located outside the publishing container and no operation on the virtual object is detected within a preset period of time, the prompt information is used for prompting that the partial area of the virtual object is located outside the publishing container.

The prompt information includes, but is not limited to, controlling the virtual object whose partial area is located outside the publishing container and/or the publishing container to display a preset special effect, the preset special effect of the virtual object including peripheral blinking or highlighting of the virtual object. The preset special effects of the publishing container include at least one of the following special effects: a change in color of an edge of the publishing container, a change in color of an exceeding area of the virtual object on the publishing container, or a change in color of an exceeding surface of the virtual object on the publishing container.
S204, in response to a moving operation on the virtual object, moving a position of the virtual object, and/or, in response to an adjustment operation on the virtual object, adjusting a size of the virtual object, causing the virtual object to be completely contained in the publishing container.

When the center position of the virtual object coincides with the center position of the publishing container, the partial area of the virtual object still exceeds the boundary of the publishing container, indicating that the virtual object is too large in size to be contained in the publishing container, and the size of the virtual object needs to be adjusted so that the virtual object is completely contained in the publishing container.

When the center position of the virtual object does not coincide with the center position of the publishing container, the partial area of the virtual object exceeds the boundary of the publishing container, which may be because the position of the virtual object is located at the edge of the publishing container, or it may be because the size of the virtual object is too large causing the partial area of the virtual object to exceed the boundary of the publishing container. At this time, the position of the virtual object may be adjusted first, and if the virtual object cannot be completely contained in the publishing container by adjusting the position of the virtual object, the size of the virtual object may be further adjusted so that the virtual object is completely contained in the publishing container.

It is possible to detect whether the center of the bounding box of the virtual object and the center of the publishing container coincide, and to determine whether the center of the virtual object coincides with the center of the publishing container. The bounding box, also referred to as a bounding body or a collision body, may be considered a transparent entity that covers or encloses all or part of the virtual object, and the bounding box may be invisible to the user.

It can be understood that, in the embodiment of the present disclosure, step S203 is an optional step. If the size of the virtual object is smaller than the publishing container, the virtual object can be completely contained in the publishing container by adjusting the position of the virtual object, and step S203 is not performed.

Typically, step S203 is performed when: Case 1, the virtual object is larger in size than the publishing container, and no matter how the user adjusts the position of the virtual object, a portion of the virtual object is located outside the publishing container. In case 2, the size of the virtual object is smaller than the publishing container, but the user does not move the virtual object for a long time when a portion of the virtual object is outside the publishing container during the process of moving the virtual object inside the publishing container.

It is to be understood that in the embodiment of the present disclosure, step S204 is an optional step, and step S203 and step S204 are performed in no sequential order. The step S204 may be performed after the step S203 or before the step S203, or the step S203 is not performed and the step S204 is performed after the step S202.

When step S203 is performed, if it is case one in step S203, i.e., the virtual object is larger in size than the publishing container, and no matter how the user adjusts the position of the virtual object, a portion of the virtual object is located outside the publishing container, in which case the size of the virtual object needs to be adjusted so that the virtual object is completely contained in the publishing container. Of course, in this case, the position of the virtual object may also be adjusted.

When the step S203 is performed, if it is the case two in the step S203, i.e., the size of the virtual object is smaller than the publishing container, but the user does not move the virtual object for a long time when a portion of the virtual object is outside the publishing container during the process of moving the virtual object inside the publishing container, in which case, the position of the virtual object needs to be adjusted. Of course, in this case, if the size of the virtual object is too big or too small, the user can also adjust the size of the virtual object.

When step S203 is not performed, the user may also adjust the position and size of the virtual object according to his or her own needs, for example, by comparing the sizes of the virtual object and the publishing container, the user may also adjust the size of the virtual object by finding that the size of the virtual object is too small. Also, in the 3D scenario, the user may not be able to accurately perceive the size of the virtual object because of the difference in the pose or position of the virtual object, at which point the user may adjust the position of the virtual object.
S205, in response to detecting that the virtual object is completely contained in the publishing container, and receiving a publication instruction, publishing the virtual object.

In this embodiment, the virtual object will not be published when both of the following publishing conditions are met: condition one, the virtual object is completely contained in the publishing container; condition two, a publishing instruction is received. In a specific implementation, there is no order of precedence in detecting whether the two publishing conditions are satisfied; in one implementation, the detection of whether a publishing instruction is received is made when the virtual object is detected to be completely contained in the publishing container, and in another implementation, the detection of whether the virtual object is completely contained in the publishing container is made when the publishing instruction is received.

In this embodiment, a publishing container and a virtual object are displayed, the publishing container is a 3D polyhedron; the virtual object is placed into a publishing container in response to a moving operation on the virtual object; when it is detected that the partial area of the virtual object is located outside the publishing container, and no operation on the virtual object is detected for a preset period of time, prompt information is displayed, based on which the user can adjust the virtual object size and/or adjust the position of the virtual object so that the virtual object is completely contained in the publishing container, and when it is detected that the virtual object is completely contained in the publishing container, and a publishing instruction is received, the virtual object is published. During the publishing process, the user experience is improved by guiding the user to resize the virtual object and/or to adjust the position of the virtual object by the prompt information.

An Embodiment of the present disclosure provides a method for publishing a virtual object to explain a publishing flow of a virtual item created using a skeletal structure, the virtual item including but not limited to a virtual character, and FIG. 7 is a flowchart of a method for publishing a virtual object according to an embodiment of the present disclosure, and as illustrated in FIG. 7, the method provided by the present embodiment includes the following steps.
S301, displaying a publishing container and a plurality of virtual objects, where the publishing container is a 3D polyhedron a skeletal structure of a virtual item is displayed in the publishing container, the skeletal structure of the virtual item includes a plurality of skeletal nodes.

The virtual item includes but is not limited to a virtual character or various virtual articles, taking the virtual character as an example, the skeletal structure of the virtual character includes a plurality of skeletal nodes including but not limited to a head node, a neck node, an extremity node, and a body node, the arm node may include a large arm node, a small arm node, a hand node, the leg node may include a thigh node, a calf node, and a foot node, the body node includes a chest node, a waist node, and the like. Taking the virtual article as a three-section stick as an example, the skeletal structure of the three-section stick includes three skeletal nodes, which correspond to three sections of the stick body. It will be appreciated that the skeletal structure may be different in different scenarios.

When the virtual character is created, virtual objects corresponding to each skeletal node are created, and mounts each virtual object on the corresponding skeletal node, thereby forming the virtual character. The virtual object to which the skeletal node corresponds can be understood as one virtual model, for example, when the skeletal node is a head model, the virtual model to which the skeletal node corresponds is a virtual head model. Each virtual model is mounted on one skeletal node, i.e. the virtual model and the skeletal node are in a one-to-one correspondence.
S302, in response to the first operation, publishing the virtual object completely contained in the publishing container and mounted on a corresponding skeletal node.

In the embodiment, the virtual object mounted on the skeletal node means that the virtual object establishes a correspondence relationship with the skeletal node, and the correspondence relationship between the virtual object and the skeletal node may be established through the attribute setting panel of the virtual object or the skeletal node, and the correspondence relationship between the virtual object and the skeletal node may be determined according to the positional relationship of each virtual object and the skeletal node, without limitation. A virtual object mounted on a skeletal node has a relative positional and/or postural relationship with the skeletal node on which it is mounted, and the corresponding skeletal node of the virtual object and its relative positional and/or postural relationship with the skeletal node may be recorded at the same time when the virtual object is published, and then the position and/or pose of the virtual object mounted on each skeletal node may be determined from the position and/or pose of the skeletal node and the relative position and/or pose of the virtual object mounted on the skeletal node when the skeletal node is controlled to change position and/or pose.

When the correspondence between the virtual object and the skeletal node is determined based on the positional relationship of the virtual object and the skeletal node, illustratively, the virtual object is determined to be mounted on the skeletal node when it is detected that a certain virtual object coincides with a certain skeletal node. The virtual object overlaps with the skeletal node may be a full overlap, may also be a partial overlap, and may also be a center position of the virtual object overlaps with a center position of the skeletal node. It will be appreciated that after determining that the virtual object is mounted on the skeletal node, the relative positional relationship between the virtual object and the skeletal node may also be adjusted.

When determining whether the virtual character overlaps with the skeletal node, it can be determined whether the bounding box of the virtual character overlaps with the bounding box of the skeletal node. Similarly, in determining whether the center position of the virtual character overlaps with the center position of the skeletal node, it can be determined whether the center position of the bounding box of the virtual character overlaps with the center position of the bounding box of the skeletal node.

In one implementation, when the virtual object corresponding to each skeletal node of the virtual item is created in the publishing container, and the virtual object corresponding to the skeletal node is already mounted on the skeletal node at the time of creation, the first operation may be a receiving operation on a publishing instruction. When the publishing instruction is received, the virtual object that is completely contained in the publishing container and mounted on the corresponding skeletal node is published, i.e., the virtual item is published.

In another implementation, when the virtual object corresponding to each skeletal node of the virtual item is created in the publishing container, but the virtual object corresponding to the skeletal node is not mounted on the skeletal node when created, the first operation may include a mounting operation on the virtual object and a receiving operation on the publishing instruction. The user first mounts each virtual character on the corresponding skeletal node through a mounting operation, and then publishes the virtual item when receiving a publishing instruction.

Alternatively, the mounting operation on the virtual object may be a moving operation on the virtual object to mount the virtual object with the skeletal node by moving the virtual object to a center position of the skeletal node.

In yet another implementation, when the virtual object corresponding to each skeletal node of the virtual item is created outside the publishing container, the virtual object needs to be moved into the publishing container and mounted on the corresponding skeletal node first, and thus, the first operation may include a moving operation on the virtual object, a mounting operation on the virtual object, and a receiving operation on a publishing instruction. In one implementation, the mounting operation of the virtual object is a moving operation, and in this case, the first operation includes moving operation on the virtual object and a receiving operation on a publishing instruction.

The user sequentially moves each virtual object to the publishing container and mounts it on the corresponding skeletal node through the moving operation, and when the user mounts the virtual object on the skeletal node through the moving operation, the user may have just moved the virtual object to the publishing container and not mounted the virtual object on the corresponding skeletal node. Therefore, there is a need to detect whether a virtual object is mounted on a skeletal node.

In this embodiment, the virtual object is determined to be a publishable model of the virtual item when it is detected that the virtual object is completely contained in the publishing container and mounted on the corresponding skeletal node. The virtual object is determined to be a non-publishable model of the virtual character when the virtual object is not completely contained in the publishing container, or the virtual object is not mounted on the corresponding skeletal node.

The publishing container is also controlled to enter a warning state when a portion of the virtual object is located outside the publishing container, prompting the user that the virtual object exceeds the publishing container. The user may move the position of the virtual object and/or adjust the size of the virtual object according to the prompt information. When publishing a virtual item that employs skeletal nodes, only the publishable model of the virtual item is published; the unpublishable model of the virtual item is not published.

The virtual item has a plurality of skeletal nodes, and accordingly, the publishable model of the virtual item is also a plurality, and when a publishing instruction input by a user is received, it is determined to publish the virtual item, and publishing the virtual item means publishing the publishable model of the virtual item. In this embodiment, only the publishable model of the virtual item is published, the non-publishable model of the virtual item is not published, and if a virtual object is not mounted on the corresponding skeletal node because of an inaccurate mount position of the user, the virtual object is ignored at the time of publishing, and the virtual object is not published.

FIG. 8 is a schematic diagram of the publishing of a virtual character. As illustrated in FIG. 8, each virtual object of the virtual character is mounted on a corresponding skeletal node. A user can open an interaction panel as illustrated in FIG. 8 through a first control on a publishing container. A publishing control, i.e., a control corresponding to “publishing character” in FIG. 8, is displayed on the interaction panel, and setting information of the virtual character or setting information of the publishing container is also displayed on the interaction panel.

For example, the interaction panel displays a skeletal scale control, which the user opens to adjust the scale of the skeletal nodes in the skeletal structure. Alternatively, the display effect of the virtual object can be adjusted by the “Translucent Display” module displayed on the interaction panel. Or, set whether to drive the virtual character through the “Drive” module on the interaction panel, and further set the drive mode.

In this embodiment, a publishing container and a plurality of virtual objects are displayed, the publishing container being a 3D polyhedron, a skeletal structure of a virtual item is displayed in the publishing container, the skeletal structure of the virtual item includes a plurality of skeletal nodes, and in response to the first operation, the virtual object completely contained in the publishing container and mounted on a corresponding skeletal node is published. In the method, by mounting the virtual object created by the user on the skeletal structure of the virtual item in the publishing container, the publication of the virtual item is realized through the publishing container, and the user can intuitively learn the size of the skeletal structure of the virtual item and the mounting situation, thereby improving the user experience.

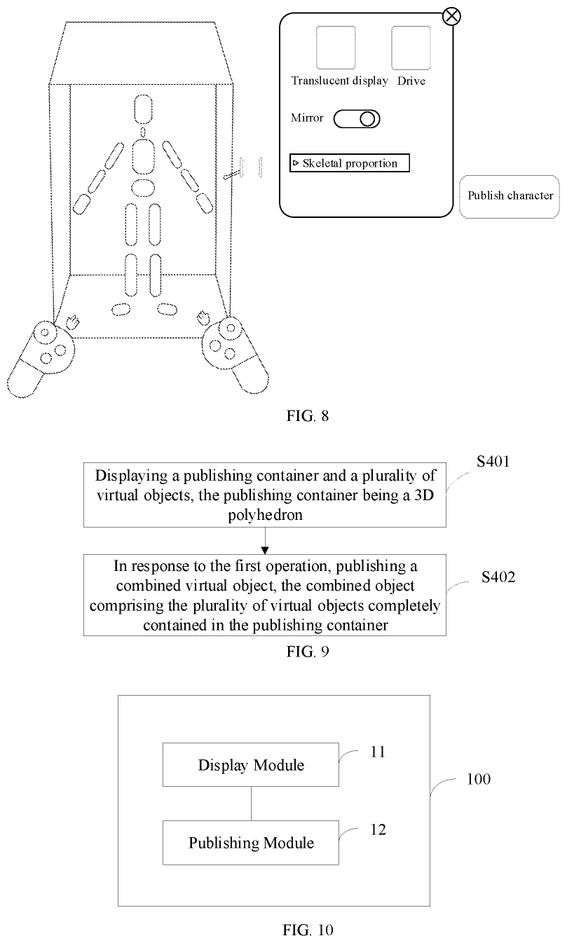

On the basis of the above embodiments, the embodiment of the present disclosure provides a method for publishing a virtual object to illustrating the publication of a combined virtual character, and FIG. 9 is a flowchart of a virtual object publishing method according to an embodiment of the present disclosure, and as illustrated in FIG. 9, the method provided by the present embodiment includes the following steps.
S401, displaying a publishing container and a plurality of virtual objects, the publishing container being a 3D polyhedron.
S402, in response to the first operation, publishing a combined virtual object, the combined object comprising the plurality of virtual objects completely contained in the publishing container.

In an extended reality scenario, there are not only combined virtual objects, but also independent virtual objects. An independent virtual object is relative to a combined virtual object, which refers to a virtual object is constituted by a plurality of sub virtual objects, each being an independent virtual object.

The meaning of “constituted” here can be understood as when the combined virtual object is published, the plurality of sub virtual objects constituting the combined virtual object are published as a whole, for example, the basketball and the basketball rim may be independent virtual objects, or they may be published as a combined virtual object as a whole, and with respect to the combined virtual object, the combined virtual object may be held as a whole, or it may be held with respect to sub virtual objects in the combined virtual object.

An independent virtual object refers to a virtual object constituted by a plurality of geometric bodies, which in the editor can be understood as a non-detachable minimal editing element, which the user can hold.

For the combined virtual object, the user may take the combined virtual object in its entirety from the user's backpack and then take the individual sub virtual objects separately. The scenario of the embodiment of the present disclosure is not limited to this scenario, the virtual character may also move the combined virtual object from one place to another while playing in the virtual scenario, and the combined virtual object may also be moved as a whole during the moving process, and then the individual sub virtual objects may be taken out respectively after moving to the target position.

The user needs to first take the sub virtual objects according to their sub holding parameters according to the combined holding parameters.

In this embodiment, when a user places a plurality of independent virtual objects into a publishing container, the plurality of separate virtual objects may be combined to form a combined virtual object, and the combined virtual object may be published. Each virtual object of the plurality of virtual objects is a sub virtual object of a combined virtual object, and publishing the combined virtual object may be understood as publishing each virtual object completely contained in the publishing container as a sub virtual object of the combined virtual object.

In one implementation, a user places a plurality of independent virtual objects into a publishing container and by default combines the plurality of independent virtual objects to form a combined virtual object for publishing in the form of a combined virtual object.

In another implementation, after a user places a plurality of independent virtual objects into a publishing container, a publishing option is displayed in response to a display instruction, the publishing option being used to select whether to combine the plurality of virtual objects to form a combined virtual object. A selection operation for the publishing option is received, and when the selection operation indicates to combine the plurality of virtual objects to form the combined virtual object, the plurality of virtual objects are determined to be combined to form the combined virtual object based on the selection operation.

Optionally, when the selection operation indicates that the plurality of virtual objects are not combined to form a combined virtual object, the plurality of virtual objects are published simultaneously as independent virtual objects. In this manner, the plurality of virtual objects are published at the same time, and each virtual object remains an independent virtual object after publishing.

In this embodiment, a publishing container and a plurality of virtual objects are displayed, the publishing container being a 3D polyhedron; in response to a first operation on each virtual object, a combined virtual object is published, the combined object including a plurality of virtual objects completely contained in a publishing container. In the method, the plurality of virtual objects are published as a combined virtual object, making the publication of the combined virtual object easier and faster.

As an alternative implementation, when it is detected that a plurality of virtual objects are completely contained in the publishing container, a plurality of independent virtual objects are published in response to the first operation, each of the independent virtual objects corresponding to one of the virtual objects completely contained in the publishing container. In this implementation, a plurality of virtual objects can be published at a time, the user does not need to input a publishing instruction once at the time of publishing each virtual object, which simplifies the user operation and improves the publishing efficiency. And placing a plurality of virtual objects into the publishing container at the same time, facilitating the user to compare sizes of the plurality of virtual objects to confirm whether size proportions of the plurality of virtual objects are coordinated, if it is found that the size of a certain virtual object is too small or too large, the size of the virtual object can be modified in time.

Optionally, before publishing the plurality of individual virtual objects, a publishing option may also be displayed to the user, the publishing option being used to select whether to publish the plurality of virtual objects independently, the implementation referring to a combined publishing process.

To facilitate better implementation of the method for publishing the virtual object of the embodiments of the present disclosure, the embodiments of the present disclosure further provide an apparatus for publishing the virtual object. FIG. 10 is a structural schematic diagram of an apparatus for publishing a virtual object according to an embodiment of the present disclosure. As illustrated in FIG. 10, the apparatus for publishing the virtual object 100 may include:
a display module 11 configured to display a publishing container and at least one virtual object, the publishing container being a three-dimensional polyhedron;
a publishing module 12 configured to, in response to a first operation, publish a virtual object completely contained in the publishing container.

In some embodiments, the publishing module 12 is specifically configured to:
in response to a first operation on the virtual object, move the virtual object into the publishing container;
in response to detecting that the virtual object is completely contained in the publishing container, publish the virtual object.

In some embodiments, the apparatus further includes a creating module, configured to:
before the display module 11 displays at least one virtual object, create the virtual object in the publishing container, the virtual object created being completely contained in the publishing container.

In some embodiments, the publishing module 12 is specifically configured to:
in response to receiving a publishing instruction, publish the virtual object.

In some embodiments, a publishing control is displayed at a preset position of the publishing container, and the publishing module 12 is specifically configured to:
in response to a second operation on the publishing control, publish the virtual object.

In some embodiments, a first control is displayed at a preset position of said publishing container, and the publication module 12 is specifically configured to:
receive a third operation on the first control and displaying an interaction panel, a publishing control being displayed on the interaction panel;
in response to a second operation on the publishing control, publish the virtual object.

In some embodiments, the publishing module 12 is specifically configured to:
in response to a moving operation on the virtual object, move the virtual object into the publishing container.

In some embodiments, the publishing module 12 is specifically configured to:
in response to the first operation on the virtual object, move a center position of the virtual object to a center position of the publishing container.

In some embodiments, the display module 11 is specifically configured to:
when a partial area of the virtual object is detected to be located outside the publishing container, display prompt information.

In some embodiments, the display module 11 is further configured to:
when a partial area of the virtual object is detected to be located outside the publishing container and no operation on the virtual object is detected within a preset period of time, display prompt information.

In some embodiments, the display module 11 is further configured to:
when a partial area of the virtual object is detected to be located outside the publishing container, controlling the virtual object whose partial area is located outside the publishing container and/or the publishing container to display a preset special effect.

In some embodiments, the preset special effect of the virtual object includes: peripheral blinking or highlighting of the virtual object; or
the preset special effect of the publishing container includes at least one of following special effects: a change in color of an edge of the publishing container, a change in color of an exceeding area of the virtual object on the publishing container, a change in color of an exceeding surface of the virtual object on the publishing container, where a partial area of the virtual object is located outside the publishing container.

In some embodiments, the apparatus further includes:
a moving module configured to, in response to a moving operation on the virtual object, move a position of the virtual object, causing the virtual object to be completely contained in the publishing container;
and/or, adjustment module configured to, in response to an adjustment operation on the virtual object, adjust a size of the virtual object, causing the virtual object to be completely contained in the publishing container.

In some embodiments, the display module 11 is further configured to:
in response to detecting that a target model touches an edge of the publishing container, controlling a touching area or a surface where the touching area is located to be displayed differently from other areas of the publishing container, wherein the target model is a virtual model of a controller corresponding to an extended reality scenario.

In some embodiments, a skeletal structure of a virtual item is displayed in the publishing container, the skeletal structure of the virtual item includes a plurality of skeletal nodes;
the publishing module 12 is specifically configured to:
in response to the first operation, publish the virtual object completely contained in the publishing container and mounted on a corresponding skeletal node.

In some embodiments, the publishing module 12 is further configured to:
in response to detecting that the virtual object overlaps the skeletal node, determine that the virtual object is mounted on the skeletal node.

In some embodiments, a plurality of virtual objects are completely contained in the publishing container, and the publishing module 12 is specifically configured to:
in response to the first operation, publishing a combined virtual object, the combined object comprising the plurality of virtual objects completely contained in the publishing container.

In some embodiments, the publishing module 12 is specifically configured to:
in response to the first operation, publishing each virtual object completely contained in the publishing container as a sub virtual object of the combined virtual object.

In some embodiments, a plurality of virtual objects are completely contained in the publishing container, and the publishing module 12 is specifically configured to:
in response to the first operation, publish a plurality of independent virtual objects, each independent virtual object corresponding to a virtual object completely contained in the publishing container.

In some embodiments, the size of the publishing container is determined based on a size threshold of a virtual object in an application.

In some embodiments, the size of the publishing container is determined based on a size threshold of a virtual object in an application, the size threshold corresponding to different types of virtual objects being different.

In some embodiments, the publishing container is a transparent entity or a translucent entity.

In some embodiments, the display module 11 is specifically configured to:
in response to a summoning instruction with respect to the publishing container,
display the publishing container.

In some embodiments, the display module 11 is further configured to:
in response to a closing instruction with respect to the publishing container, hide the publishing container.

In some embodiments, the virtual object is a user-defined object.

It should be understood that the embodiment of the apparatus and the embodiment of the method can correspond to each other, and similar descriptions can refer to the embodiment of the method, and to avoid repetition, is not repeated here again.

The apparatus 100 of the embodiments of the present disclosure is described from the perspective of the functional module in conjunction with the drawings. It should be understood that the functional module can be implemented through hardware, software instructions, or a combination of hardware and software modules. Specifically, the steps of the method embodiment in the embodiments of the present disclosure may be accomplished by the integrated logic circuit of hardware in the processor and/or the instruction in the form of software. The steps of the method disclosed in conjunction with the embodiments of the present disclosure may be directly performed by a hardware decoding processor, or performed by combining hardware and software modules in a decoding processor. Optionally, the software module may be located in a random memory, a flash memory, a read-only memory, a programmable read-only memory, an electrically erasable programmable memory, a register, and other mature storage media in the art. The storage medium is located in the memory, and the processor reads the information in the memory to complete the steps in the above embodiment of the method in combination with its hardware.

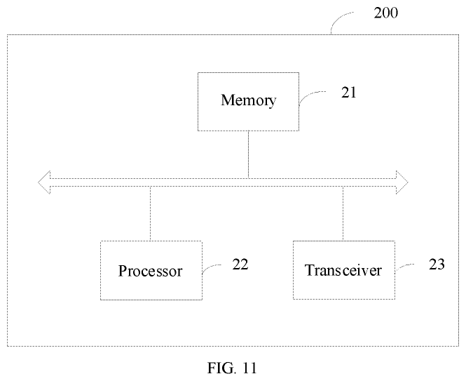

An embodiment of the present disclosure further provides an electronic device. FIG. 11 is a structural schematic diagram of an electronic device according to an embodiment of the present disclosure. As illustrated in FIG. 11, the electronic device 200 may include:
a memory 21 and a processor 22. The memory 21 is used to store the computer program and transfer the program code to the processor 22. In other words, the processor 720 may call and run the computer program from the memory 21 to achieve the method in the embodiments of the present disclosure.

For example, the processor 22 may be used to execute the embodiment of the aforementioned method based on the instruction in the computer program.

In some embodiments of the present disclosure, the processor 22 may include but is not limited to:
a general-purpose processor, a digital signal processor (DSP), an application specific integrated circuit (ASIC), a field programmable gate arrays (FPGA), or other programmable logic devices, discrete gate or transistor logic devices, discrete hardware components, and the like.

In some embodiments of the present disclosure, the memory 21 includes but is not limited to:
a volatile memory and/or a non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM), which is used as an external cache. By way of illustration but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a direct Rambus RAM (DR RAM).

In some embodiments of the present disclosure, the computer program may be divided into one or more modules, which are stored in the memory 21 and executed by the processor 22 to complete the method provided in the present disclosure. The one or more modules may be a series of computer program instruction segments capable of completing a specific function, and the instruction segments are used to describe the execution process of the computer program in the electronic device.

As illustrated in FIG. 11, the electronic device may further include: a transceiver 23, which may be connected to the processor 22 or the memory 21.

The processor 22 may control the transceiver 23 to communicate with other devices, specifically, sending information or data to other devices, or receiving information or data sent by the other devices. The transceiver 23 may include a transmitter and a receiver. The transceiver 23 may further include antennas, and the number of antennas may be one or more.

It is to be understood that, although not illustrated in FIG. 11, the electronic device 200 may further include a camera module, a wireless fidelity WIFI module, a positioning module, a Bluetooth module, a display, a controller, and the like, which are not described in detail herein.

It should be understood that the various components in the electronic device are connected through a bus system, which includes a power bus, a control bus, and a status signal bus, in addition to a data bus.

The present disclosure also provides a non-transient computer-readable storage medium on which a computer program is stored, and when the computer program is executed by the processor, it enables the processor to execute the method provided by the embodiments of the above method. In other words, embodiments of the present disclosure also provide a computer program product including instructions that, when executed by a processor, cause the processor to perform the method of the above method embodiments.

The present disclosure also provides a computer program product including computer programs stored in a non-transient computer-readable storage medium. The processor of the electronic device reads the computer programs from the non-transient computer-readable storage medium, the processor executes the computer programs, so that the electronic device performs the corresponding process in the method for publishing the virtual object in the embodiments of present disclosure, which are not repeated herein for brevity.

In the several embodiments provided in the present disclosure, it should be understood that the systems, apparatuses, and methods disclosed, may be implemented in other ways. For example, the embodiments of the apparatus described above are only illustrative. For example, the division of the modules is only a logical function division, there may be other division approaches in actual implementation, for example, a plurality of modules or components may be combined or may be integrated into another system, or some features may be ignored, or not implemented. In another point, the mutual coupling or direct coupling or communication connection shown or discussed may be indirect coupling or communication connection through some interfaces, devices or modules, and may be in electrical, mechanical or other forms.

The module illustrated as a separated component may or may not be physically separated, and a component displayed as a module may or may not be a physical module, that is, it may be located in one place, or may also be distributed to multiple network units. Part or all of the modules can be selected according to actual needs to achieve the purpose of the solution of the embodiment. For example, various functional modules in various embodiments of the present disclosure may be integrated into one processing module, each module may exist separately physically, or two or more modules may be integrated into one module.

What are described above is related to the specific embodiments of the present disclosure only, and the scope of the present disclosure is not limited to this. Anyone skilled in the art can easily think of changes or substitutions within the scope of the technology disclosed in the present disclosure, which should be covered within the protection scope of the present disclosure. Therefore, the scopes of the present disclosure are defined by the accompanying claims.

1. A method for publishing a virtual object, comprising:
displaying a publishing container and at least one virtual object, the publishing container being a 3D polyhedron; and
in response to a first operation, publishing a virtual object completely contained in the publishing container.

2. The method according to claim 1, wherein the in response to a first operation, publishing a virtual object completely contained in the publishing container comprises:
in response to a first operation on the virtual object, moving the virtual object into the publishing container; and
in response to detecting that the virtual object is completely contained in the publishing container, publishing the virtual object.

3. The method according to claim 1, wherein before the displaying at least one virtual object, the method further comprises:
creating the virtual object in the publishing container, wherein the virtual object created is completely contained in the publishing container.

4. The method according to claim 1, wherein the in response to a first operation, publishing a virtual object completely contained in the publishing container comprises:
in response to receiving a publishing instruction, publishing the virtual object.

5. The method according to claim 4, wherein the in response to receiving a publishing instruction, publishing the virtual object comprises:
in response to a second operation on a publishing control, publishing the virtual object, wherein the publishing control is displayed at a preset position of the publishing container;
or,
receiving a third operation on a first control and displaying an interaction panel, wherein a publishing control is displayed on the interaction panel, the first control is displayed at a preset position of the publishing container; and
in response to a second operation on the publishing control, publishing the virtual object.

6. The method according to claim 2, wherein the in response to a first operation on the virtual object, moving the virtual object into the publishing container comprises:
in response to a moving operation on the virtual object, moving the virtual object into the publishing container;
or,
in response to the first operation on the virtual object, moving a center position of the virtual object to a center position of the publishing container.

7. The method according to claim 1, further comprising:
when a partial area of the virtual object is detected to be located outside the publishing container, displaying prompt information.

8. The method according to claim 7, wherein the when a partial area of the virtual object is detected to be located outside the publishing container, displaying prompt information, comprises:
when a partial area of the virtual object is detected to be located outside the publishing container and no operation on the virtual object is detected within a preset period of time, displaying prompt information;
or,
when a partial area of the virtual object is detected to be located outside the publishing container, controlling the virtual object whose partial area is located outside the publishing container and/or the publishing container to display a preset special effect,
wherein the preset special effect of the virtual object comprises: peripheral blinking or highlighting of the virtual object; or
the preset special effect of the publishing container comprises at least one of following special effects: a change in color of an edge of the publishing container, a change in color of an exceeding area of the virtual object on the publishing container, or a change in color of an exceeding surface of the virtual object on the publishing container, wherein a partial area of the virtual object is located outside the publishing container.

9. The method according to claim 1, further comprising:
in response to a moving operation on the virtual object, moving a position of the virtual object, causing the virtual object to be completely contained in the publishing container; and/or,
in response to an adjustment operation on the virtual object, adjusting a size of the virtual object, causing the virtual object to be completely contained in the publishing container.

10. The method according to claim 1, further comprising:
in response to detecting that a target model touches an edge of the publishing container, controlling a touching area or a surface where the touching area is located to be displayed differently from other areas of the publishing container, wherein the target model is a virtual model of a controller corresponding to an extended reality scenario.

11. The method according to claim 1, wherein a skeletal structure of a virtual item is displayed in the publishing container, the skeletal structure of the virtual item comprises a plurality of skeletal nodes;
the in response to a first operation, publishing a virtual object completely contained in the publishing container, comprises:
in response to the first operation, publishing the virtual object completely contained in the publishing container and mounted on a corresponding skeletal node; and
the method further comprises:
in response to detecting that the virtual object overlaps the skeletal node, determining that the virtual object is mounted on the skeletal node.

12. The method according to claim 1, wherein a plurality of virtual objects are completely contained in the publishing container;
the in response to a first operation, publishing a virtual object completely contained in the publishing container, comprises:
in response to the first operation, publishing a combined virtual object, the combined object comprising the plurality of virtual objects completely contained in the publishing container;
wherein the in response to the first operation, publishing a combined virtual object, comprises:
in response to the first operation, publishing each virtual object completely contained in the publishing container as a sub virtual object of the combined virtual object.

13. The method according to claim 1, wherein a plurality of virtual objects are completely contained in the publishing container;
the in response to a first operation, publishing a virtual object completely contained in the publishing container, comprises:
in response to the first operation, publishing a plurality of independent virtual objects, each independent virtual object corresponding to a virtual object completely contained in the publishing container.

14. The method according to claim 1, wherein a size of the publishing container is determined based on a size threshold of a virtual object in an application.

15. The method according to claim 1, wherein the publishing container is a transparent entity or a translucent entity.

16. The method according to claim 1, wherein the displaying a publishing container comprises:
in response to a summoning instruction with respect to the publishing container, displaying the publishing container; and
the method further comprises:
in response to a closing instruction with respect to the publishing container, hiding the publishing container.

17. The method according to claim 1, wherein the virtual object is a user-defined object.

18. An electronic device, comprising:
at least one processor and at least one memory, wherein the memory is configured to store computer programs, and the processor is configured to call and run the computer programs stored in the memory to execute a method for publishing a virtual object, and the method comprises:
displaying a publishing container and at least one virtual object, the publishing container being a three-dimensional polyhedron;
in response to a first operation, publishing a virtual object completely contained in the publishing container.

19. A non-transient computer-readable storage medium configured to store computer programs, wherein upon being executed by a processor, the computer programs cause the processor to implement the method according to claim 1.
